(19) United States
(12) Patent Application Publication
(10) Pub. No.: US 2018/0321388 A1
(43) Pub. Date: Nov. 8, 2018

(54) Methods, Devices And A Computer-Readable Storage Medium With Instructions For Locating A Datum Detected By A Motor Vehicle

(71) Applicant: Volkswagen Aktiengesellschaft, Wolfsburg (DE)

(72) Inventor: Stephan Max, Gifhorn (DE)

(73) Assignee: Volkswagen Aktiengesellschaft, Wolfsburg (DE)

(21) Appl. No.: 15/970,914

(22) Filed: May 4, 2018

(30) Foreign Application Priority Data
May 4, 2017 (DE) 10 2017 207 544.9

(51) Int. Cl. G01S 19/45; G01C 21/30; G01S 19/40; G01S 19/51

(52) U.S. Cl. CPC G01S 19/45; G01S 19/51; G01S 19/40; G01C 21/30

(57) ABSTRACT

A method, device and computer-readable storage medium with instructions for locating a datum detected by a motor vehicle. In a first step, at least one datum is detected (10) by a sensor system of the motor vehicle. In addition, additional data are determined (11) that make it possible to locate the at least one detected datum. The at least one detected datum and the additional data can be stored (12) in a memory of the motor vehicle. In an additional step, a data package is generated (13) by linking the additional data to the at least one detected datum. The data package can then be transmitted (14) to a back end independently or as a reaction to a request.

### CROSS REFERENCE TO RELATED APPLICATIONS

This application claims priority to DE Application No. 10 2017 207 544.9 filed May 4, 2017 with the German Patent and Trademark Office, the contents of which application are hereby incorporated by reference in their entireties.

### TECHNICAL FIELD

The present invention relates to methods, devices, and a computer-readable storage medium with instructions for locating a datum detected by a motor vehicle. The invention furthermore relates to a motor vehicle in which a method according to the invention, or device according to the invention, is used.

In modern vehicles, a wide range of data is collected. These data can be transmitted to a server and used for other purposes outside of the vehicle. The relevant data result from measurements that are performed by vehicle surround sensors. Examples of such surround sensors are cameras, radar sensors, ultrasonic sensors, etc.

In addition to the actual measured data, frequently the time of the measurement and the position of the measurement are transferred. These additional data are generally determined with the assistance of a GPS receiver (GPS: global positioning system).

### BACKGROUND

Against this background, DE 10 2013 210 395 A1 describes a method for data communication between a plurality of motor vehicles and a vehicle-external central information pool. The motor vehicles each have an automatic driving mode. From the plurality of motor vehicles, data are transferred to the central information pool that contain information on the switching-on of the automated driving mode as well as a switching-on location of the driving mode and/or information on the switching-off of the automated driving mode as well as a switching-off location of the driving mode for the respective vehicle. By using the received data, the information pool can draw conclusions about the locations at which the switching-on and/or the switching-off of the automated driving mode are possible and especially recommendable.

For a series of applications, the imprecision of position measurements by the GPS receiver is problematic. Depending on the situation, the deviations from the actual position can be more than 10 m. The measured data therefore cannot be assigned to individual lanes. Particularly with multilane roads, it is particularly important to detect which lane is blocked or backed up, to only cite two examples.

For more precise position determining, various approaches have been developed. Most approaches are based on a combination of information that is determined by a surround sensor system using a highly precise map available in the vehicle. This map contains, for example, a lane model that has already been determined beforehand, and it can assign the current measurement, in combination with a GPS measurement, to a lane-precise position.

In this context, the work of D. Niehues: “Hochgenaue Positionsbestimmung von Fahrzeugen als Grundlage autonomer Fahrregime im Hochgeschwindigkeitsbereich” (Highly-precise positioning of vehicles as a basis for autonomous driving regimens in the high-speed range) describes a method for determining the position of vehicles. Among other things, the combination of video-based lane recognition in conjunction with a highly precise digital map for additionally supporting the vehicle position is described. The lane spacing, the alignment and the curvature are identified by a video camera for lane markings on the left and right next to the vehicle. Based on these data, a transverse offset of the vehicle is determined by a comparison with data from a digital map.

From DE 10 2015 206 342 A1, a method is known for correcting a position of a vehicle. With the assistance of a satellite navigation system, a first vehicle position is determined and fit into a digital map. By means of a surround sensor system, objects in the surroundings of the vehicle are also detected, the positions of which can be referenced in the digital map. By using the actual distances of the vehicle to the detected objects, a corrected position of the vehicle is finally determined. The vehicle is connected to a map server in order to provide the digital map.

US 2017/0016740 A1 describes a method for determining a vehicle position. Geometric properties of a fixed geographic object are determined in an image that is detected by a vehicle camera. Based on the geometric properties, a vehicle location is determined with reference to the fixed geographic object. Based on the vehicle location with reference to the fixed geographic object determined in this manner, a lane-related vehicle location is finally determined on a digital map. The fixed geographic object can, for example, be a building. Lane markings can help determine vehicle position or be used to confirm a projected lane-related position.

Common to all of the described solutions is the fact that a highly precise and always current digital map must be provided in the vehicle. This results in significant expense in vehicles and a very great deal of effort to update the digital map.

### SUMMARY

An object exists to provide solutions for locating a datum detected by a motor vehicle that enable locating with improved precision without a highly precise map having to be provided in the motor vehicle.

This object is solved by a method with the features of one or more of the method claims, by a computer-readable storage medium with instructions according to the respective medium claim, and by a device with the features of one or more of the apparatus claims. Embodiments of the invention are the subject matter of the dependent claims and the following description.

According to a first aspect, a method for locating a datum detected by a motor vehicle comprises the steps:
detecting at least one datum by means of a sensor system of the motor vehicle;
determining additional data that enable a locating of the at least one detected datum, wherein the additional data comprise at least local surroundings data detected by the sensor system of the motor vehicle; and
generating a data package by linking the additional data to the at least one detected datum.

According to another aspect, a computer-readable storage medium contains instructions that, when executed by a computer, cause the computer to execute the following steps for locating a datum detected by a motor vehicle:
detecting at least one datum by means of a sensor system of the motor vehicle;
determining additional data that enable a locating of the at least one detected datum, wherein the additional data comprise at least local surroundings data detected by the sensor system of the motor vehicle; and
generating a data package by linking the additional data to the at least one detected datum.

The term computer is to be interpreted broadly. In a particular example, the term also comprises/encompasses control units and other processor-based data processing devices.

According to another aspect, a device for locating a datum detected by a motor vehicle comprises:
a data detection unit for detecting at least one datum by means of a sensor system of the motor vehicle;
an additional data determining unit for determining additional data that enable a locating of the at least one detected datum, wherein the additional data comprise at least local surroundings data detected by the sensor system of the motor vehicle; and
a data processing unit for generating a data package by linking the additional data to the at least one detected datum.

### BRIEF DESCRIPTION OF THE DRAWINGS

The invention is explained in the following using various exemplary embodiments.

FIG. 1 schematically shows a method for locating a datum detected by a motor vehicle from the perspective of the motor vehicle;

FIG. 2 shows a first embodiment of a device that can be installed in a motor vehicle for locating a datum detected by a motor vehicle;

FIG. 3 shows a second embodiment of a device that can be installed in a motor vehicle for locating a datum detected by a motor vehicle;

FIG. 4 schematically shows a motor vehicle in which a solution according to an embodiment is realized;

FIG. 5 schematically shows a method for locating a datum detected by a motor vehicle from the perspective of a back end;

FIG. 6 shows a first embodiment of a device that can be installed in a back end for locating a datum detected by a motor vehicle;

FIG. 7 shows a second embodiment of a device that can be installed in a back end for locating a datum detected by a motor vehicle;

FIG. 8 illustrates a known system for detecting and positioning data detected by a motor vehicle;

FIG. 9 illustrates a system according to another embodiment for detecting and positioning data detected by a motor vehicle;

FIG. 10 illustrates the continuous detection and saving of data for positioning as well as the detection and saving of data for a local event;

FIG. 11 illustrates the generation of a data package as a reaction to a detected event;

FIG. 12 shows the continuous detection and saving of local data and data for positioning; and

FIG. 13 illustrates the use of continuous detection and saving of local data and data for positioning with the example of parking space data.

### DETAILED DESCRIPTION OF EMBODIMENTS

With regard to a method that can be used in a motor vehicle or a device that can be installed in a motor vehicle and in corresponding embodiments, a detected datum is expanded with local surroundings data detected by the sensor system of the motor vehicle before being sent to a back end. Based on these local surroundings data, the back end can later undertake improved locating, for example reconstruct the lane assignment.

In corresponding embodiments and in a first step, relevant information is determined by the sensor system of the motor vehicle, i.e., a datum (also referred to as information in the following) is detected. In corresponding embodiments, the associated position data may be appended to this information such as GPS position, orientation, speed, etc. Furthermore, additional local surroundings data may then be added. These data may be cumulatively sent to the back end. From there, in one embodiment, it is now possible to position the data very precisely. For this purpose, the information about the local surroundings data may be compared to data from a database available to the back end. In this manner, the lane in which the vehicle is currently located may, for example, be determined. In this context, a single measurement is sufficient for a lane assignment in the simplest case. If the single measurement does not yield a clear result, the history of the determined positions may be used for the lane assignment.

A benefit of the described exemplary solution is that calculations for positioning do not have to be performed in the motor vehicle, and computing time therefore also does not have to be expended for this purpose. Furthermore, a database with data for the comparison with the local surroundings data does not have to be kept in the motor vehicle since this comparison occurs in the back end. Accordingly, no additional cost arises from providing such a database in the motor vehicle. The effort of continuously updating the data in such a database is also omitted, for which a nearly constant motor vehicle data link would be necessary. The effort in the vehicle and the data volume to be transported are significantly reduced by the solution according to some embodiments described herein. Consequently, the solution can be implemented not just in expensive premium vehicles in combination with various add-on packages, but also in motor vehicles in other price classes. This is beneficial since to achieve a very large measuring density, the provision of the data must ideally be carried out by as many vehicles as possible.

According to some embodiments, the at least one detected datum and the additional data are stored in a memory of the motor vehicle. The saving of this data makes it possible to only generate data packages when it is necessary, for example when it is found that transmission of the data is necessary. This can be the case when a data link is available, or when relevant data occur in the detected data. Likewise, the saving makes it possible to adapt the amount of local surroundings data that are included in a data package to the type of the relevant data. In addition, the saved data can thus be subsequently accessed, for example if the back end requests additional surroundings data.

According to some embodiments, the data package is transmitted to a back end independently or as a reaction to a request. By independently transmitting the data, a push mechanism is realized in which rules archived in the motor vehicle establish which data are transmitted at which time. Contrastingly in a pull mechanism, the data are actively requested, for example by the back end. For example, data can thus be requested from vehicles that are moving in regions with a small database. It is likewise possible to only request certain types of information such as data on the road condition, or to influence the measuring frequency, for example to achieve a greater or lesser measuring density for certain data. In this manner, the arising data volume can on the one hand be controlled, and the relevance of the detected data can on the other hand be increased.

According to some embodiments, data continuously detected by the sensor system of the motor vehicle and additional data are linked into data packages, or a data package is generated as a reaction to the at least one detected datum. The continuous generation of data packages is independent of the detection of a special relevant event. Accordingly, for example, parking space data can be collected by continuously detecting and transmitting data from ultrasonic sensors of a park assist. Likewise, climate data can be detected by evaluating the measured data from rain, light or temperature sensors. The generation of data packages as a reaction to a detected datum is in particular relevant for the transmission of special events. Special events can for example be potholes, traffic signs, local or close hazard sites, or road conditions as well, such as black ice, aquaplaning or messes. Examples of hazard sites are accidents, closures, objects or individuals on the road, ends of traffic jams, vehicles with hazard lights or vehicles on the hard shoulder, construction sites or wrong-way drivers, to only name a few.

According to some embodiments, a scope of the additional data in a data package depends on the type of the at least one detected datum. For example, a large amount of additional data can be sent for a detected datum with a high localization requirement such as a locally identified pothole, whereas a small amount of additional data can be sent for a detected datum with a low localization requirement such as black ice. In this manner, the data transfer can be minimized.

According to further embodiments, a method for locating a datum detected by a motor vehicle comprises the steps:
receiving a data package from a motor vehicle;
extracting from the data package at least one datum detected by a sensor system of the motor vehicle;
extracting from the data package additional data that make it possible to locate the at least one detected datum; and
positioning the at least one detected datum based on the additional data, wherein local surroundings data detected by the sensor system of the motor vehicle and contained in the additional data are evaluated for positioning.

According to further embodiments, a computer-readable storage medium contains instructions that, when executed by a computer, cause the computer to execute the following steps for locating a datum detected by a motor vehicle:
receiving a data package from a motor vehicle;
extracting from the data package at least one datum detected by a sensor system of the motor vehicle;
extracting from the data package additional data that make it possible to locate the at least one detected datum; and
positioning the at least one detected datum based on the additional data, wherein local surroundings data detected by the sensor system of the motor vehicle and contained in the additional data are evaluated for positioning.

The term computer is to be interpreted broadly here as well. In a particular example, the term also comprises/encompasses work stations and other processor-based data processing devices.

According to further embodiments, a device for locating a datum detected by a motor vehicle has:
a receiving unit for receiving a data package from a motor vehicle;
a data processing unit for extracting from the data package at least one datum detected by a sensor system of the motor vehicle, and for extracting from the data package additional data that make it possible to locate the at least one detected datum; and
a positioning unit for positioning the at least one detected datum based on the additional data, wherein the positioning unit is configured to evaluate local surroundings data detected by the sensor system of the motor vehicle and contained in the additional data for positioning.

With regard to a method that can be used in a back end, or respectively a device that can be installed in a back end, and in some embodiments, first a data package transmitted by a motor vehicle is received. The processing by the back end does not need to occur directly after the reception. It is also possible for received data packages to first be saved and then only be evaluated later. The datum detected by the sensor system of the motor vehicle as well as the additional data are extracted from the data package. The detected datum is positioned based on the additional data, wherein in particular the local surroundings data detected by the sensor system of the motor vehicle are evaluated. For example, approximate positioning can be carried out by evaluating position data in the data package, whereas the local surroundings data are used for lane-precise positioning. To this end, the detected local surroundings data may, for example, be compared to a digital map that can be accessed by the back end.

A benefit of positioning by the back end is that the vehicles themselves do not have to possess a corresponding map; rather, this map only has to be available to the back end. The map can accordingly also be updated directly in the back end or by the map provider. Moreover, the map in the back end can be optimized with regard to the respective use case. If, for example, parking space occupancy information is calculated in the back end, only the relevant parking areas in the map must be kept current.

According to some embodiments, the local surroundings data detected by the sensor system of the motor vehicle comprise information on visual landmarks. Visual landmarks are understood to be objects in the surroundings that are particularly noticeable and can therefore be detected relatively easily. Such landmarks have the advantage that they can be used particularly effectively for decisions about the position of the vehicle and hence the position of the detected datum.

According to some embodiments, the visual landmarks comprise one or more of the following elements: lane markings, lane boundaries, road markings, traffic signs, guideposts, guard rails, traffic lights and construction objects. The listed objects can be determined comparatively easily by the evaluation of camera data. Many motor vehicles today are already standard equipped with cameras for detecting the surroundings, such as for traffic sign recognition or for use by a lane assist. Generally, additional hardware is unnecessary for detecting the surroundings data for the purpose of locating; the solution according to the present embodiment can therefore be realized economically.

According to some embodiments, the information on lane markings comprises one or more of the following elements: information on the distance from a lane marking, information on the existence of a lane marking, information on the color of a lane marking, information on the type of lane marking, information on the curvature of a lane marking, and information on a yaw angle of the motor vehicle. These data are typically provided by the camera systems used by current lane assists so that no additional computing effort is needed for determining these surroundings data. At the same time, the information on the lane markings can be very easily compared to map data. The information on the yaw angle makes it possible to verify the determined curvatures of the lane markings. Clear deviations between the yaw angle and the curvature suggest incorrect detection of the curvature. The available data from a front camera are portrayed in the following table as an example, wherein the entry “Y distance” indicates the distance of the vehicle center to the line in the Y axis, i.e., how far to the side the vehicle is distant from the lane marking:

ECAN::BV_Line_01::BV_Line_01_Y_distance (12 Bit/1 Hz)
ECAN::BV_Line_01::BV_Line_01_measure of existence (6 Bit/
1 Hz)
ECAN::BV_Line_01::BV_Line_01_color (3 Bit/1 Hz)
ECAN::BV_Line_01::BV_Line_01_yaw angle difference (12 Bit/
1 Hz)
ECAN::BV_Line_01::BV_Line_01_horizontal_curvature_change
(12 Bit/1 Hz)
ECAN::BV_Line_01::BV_Line_01_horizontal_curvature (12 Bit/
1 Hz)
ECAN::BV_Line_01::BV_Line_01_line number (4 Bit/1 Hz)
ECAN::BV_Line_01::BV_Line_01_Type (3 Bit/1 Hz)
ECAN::BV_Line_02::BV_Line_02_Y_distance (12 Bit/1 Hz)
ECAN::BV_Line_02::BV_Line_02_measure of existence (6 Bit/
1 Hz)
ECAN::BV_Line_02::BV_Line_02_color (3 Bit/1 Hz)
ECAN::BV_Line_02::BV_Line_02_yaw angle difference (12 Bit/1 Hz)
ECAN::BV_Line_02::BV_Line_02_horizontal_curvature_change
(12 Bit/1 Hz)
ECAN::BV_Line_02::BV_Line_02_horizontal_curvature (12 Bit/
1 Hz)
ECAN::BV_Line_02::BV_Line_02_line number (4 Bit/1 Hz)
ECAN::BV_Line_02::BV_Line_02_Type (3 Bit/1 Hz)
ECAN::BV_Line_03::BV_Line_03_Y_distance (12 Bit/1 Hz)
ECAN::BV_Line_03::BV_Line_03_measure of existence (6 Bit/
1 Hz)
ECAN::BV_Line_03::BV_Line_03_color (3 Bit/1 Hz)
ECAN::BV_Line_03::BV_Line_03_yaw angle difference (12 Bit/
1 Hz)
ECAN::BV_Line_03::BV_Line_03_horizontal_curvature_change
(12 Bit/1 Hz)
ECAN::BV_Line_03::BV_Line_03_horizontal_curvature (12 Bit/
1 Hz)
ECAN::BV_Line_03::BV_Line_03_line number (4 Bit/1 Hz)
ECAN::BV_Line_03::BV_Line_03_Typ (3 Bit/1 Hz)
ECAN::BV_Line_04::BV_Line_04_Y_distance (12 Bit/1 Hz)
ECAN::BV_Line_04::BV_Line_04_measure of existence (6 Bit/
1 Hz)
ECAN::BV_Line_04::BV_Line_04_color (3 Bit/1 Hz)
ECAN::BV_Line_04::BV_Line_04_yaw angle difference (12 Bit/
1 Hz)
ECAN::BV_Line_04::BV_Line_04_horizontal_curvature_change
(12 Bit/1 Hz)
ECAN::BV_Line_04::BV_Line_04_horizontal_curvature (12 Bit/
1 Hz)
ECAN::BV_Line_04::BV_Line_04_line number (4 Bit/1 Hz)
ECAN::BV_Line_04::BV_Line_04_Type (3 Bit/1 Hz)

For example, four lanes are each detected by the camera; the lanes to the right and left of the home lane, and the respective missing lane consisting of the adjacent lane. If the transmitting vehicle is on a multilane road with too many lanes so that the measurement does not yield a clear result, the history of the determined lanes can be used for the lane assignment. In the present example, this can occur with five or more lanes.

In some embodiments, a method according to the preceding and following discussion or a device according to the preceding and following discussion is used in a vehicle, in particular a motor vehicle.

Additional features, advantages, and embodiments of the present invention will become apparent from the following description and the appended claims in conjunction with the FIGS.

To better understand the principles of the present invention, further exemplary embodiments will be explained in the following in greater detail with reference to the FIGS. Of course, the current invention is not restricted to these or the preceding embodiments. The described features and embodiments can also be combined or modified without departing from the scope of the present invention as defined in the appended claims.

FIG. 1 schematically shows a method for locating a datum detected by a motor vehicle from the perspective of the motor vehicle. In a first step, at least one datum is detected 10 by a sensor system of the motor vehicle. In addition, additional data are determined 11 that make it possible to locate the at least one detected datum. The additional data comprise at least local surroundings data detected by the sensor system of the motor vehicle. The at least one detected datum and the additional data can be stored 12 in a memory of the motor vehicle. In an additional step, a data package is generated 13 by linking the additional data to the at least one detected datum. The data package is then transmitted 14 to a back end independently or as a reaction to a request. The data detected by the sensor system of the motor vehicle and the additional data can be continuously linked into data packages. Alternatively or in addition, a data package can also be generated 13 as a reaction to the at least one detected datum. The scope of the additional data in a data package can depend on the type of the at least one detected datum.

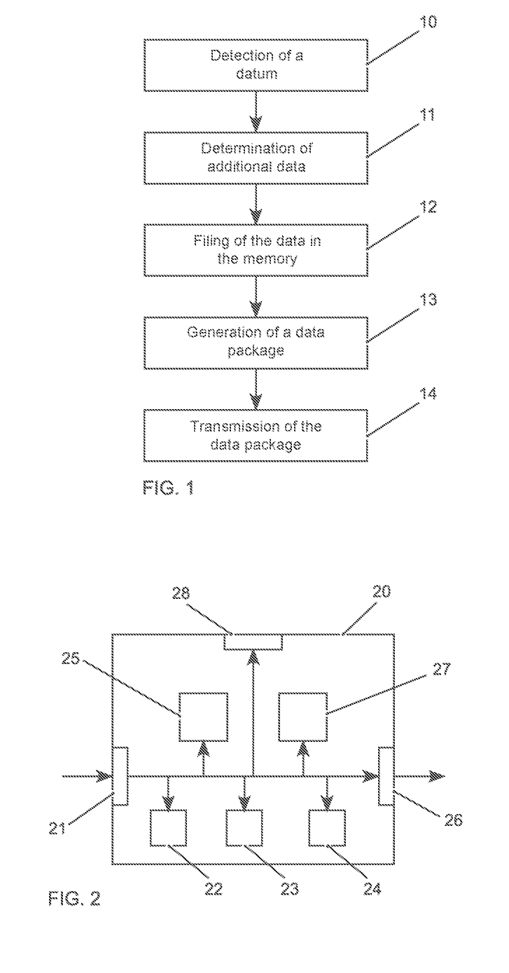

FIG. 2 shows a simplified schematic representation of a first embodiment of a device 20 that can be installed in a motor vehicle for locating a datum detected by a motor vehicle. The device 20 has an input 21 to receive data that permit locating. A data detection unit 22 detects at least one datum by means of a sensor system of the motor vehicle. An additional data determining unit 23 determines additional data that make it possible to locate the at least one detected datum. The additional data comprise at least local surroundings data that were detected by the sensor system of the motor vehicle. A data processing unit 24 finally generates a data package by linking the additional data to the at least one detected datum. The data detected by the sensor system of the motor vehicle and the additional data can be continuously linked into data packages. Alternatively or in addition, a data package can also be generated as a reaction to the at least one detected datum. The scope of the additional data in a data package can depend on the type of the at least one detected datum. The data packages generated by the data processing unit 24 are transmitted to a back end independently or as a reaction to a request via an output 26 of the device 20. The data detection unit 22, the additional data determining unit 23 and the data processing unit 24 can be controlled by a control unit 25. If necessary, settings of the data detection unit 22, the additional data determining unit 23, the data processing unit 24 or the control unit 25 can be changed by means of a user interface 28. The data accumulating in the device 20, such as the at least one detected datum, the additional data or the generated data packages, can be stored in a memory 27 of the device 20, for example for later evaluation, or for use by the components of the device 20. The data detection unit 22, the additional data determining unit 23, the data processing unit 24 as well as the control unit 25 can be realized as dedicated hardware, such as integrated circuits. Of course, they can, however, also be partially or completely combined or implemented as software that runs on a suitable processor such as a GPU. The input 21 and output 26 can be implemented as separate interfaces or as a combined bidirectional interface.

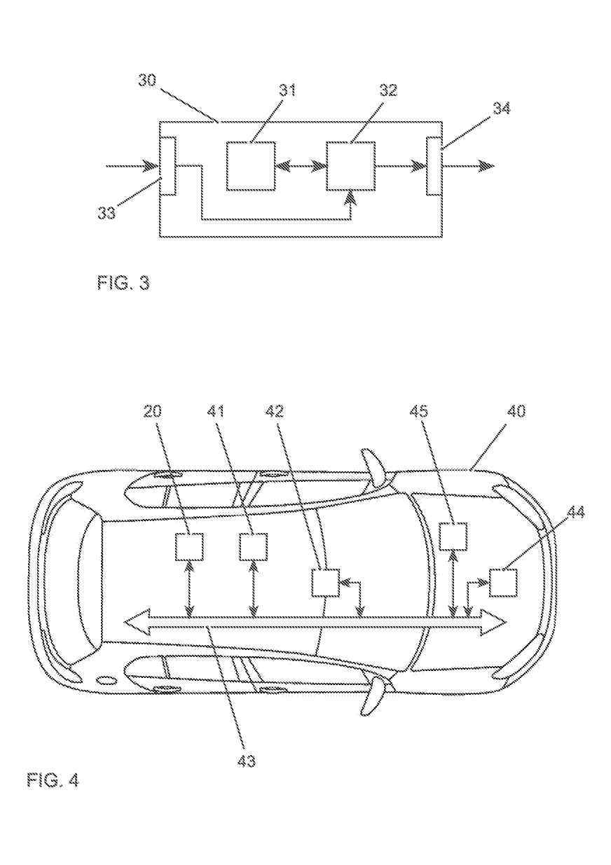

FIG. 3 shows a simplified schematic representation of a second embodiment of a device 30 that can be installed in a motor vehicle for locating a datum detected by a motor vehicle. The device 30 has a processor 32 and a memory 31. For example, the device 30 is a computer or a control unit. Instructions are stored in the memory 31 that, when executed by the processor 32, cause the device 30 to execute the steps according to one of the described methods. The instructions stored in the memory 31 thus embody a program that can be run by the processor 32 and realizes the method according some embodiments described herein. The device has an input 33 for receiving information such as data that were detected by a sensor system of the motor vehicle. Data generated by the processor 32 are provided by an output 34. Moreover, they can be stored in the memory 31. The input 33 and the output 34 can be combined into a bidirectional interface.

The processor 32 can comprise one or more processor units such as microprocessors, digital signal processors, or combinations thereof.

The memories 27, 31 of the described embodiments can have volatile as well as non-volatile memory sections and can comprise a wide range of memory units and media such as hard disks, optical storage media, or semiconductor memories.

FIG. 4 schematically shows a motor vehicle 40 in which an embodiment is realized. The motor vehicle 40 has inter alia a navigation system 41 and a surround sensor system 42 such as a camera or radar system. The data detected by the navigation system 41 and the surround sensor system 42 are transmitted via a network 43 to a device 20 for locating. The data generated by the device 20 are stored in a memory 44 of the motor vehicle 40 and transmitted as needed by a communication unit 45 to a back end for evaluation.

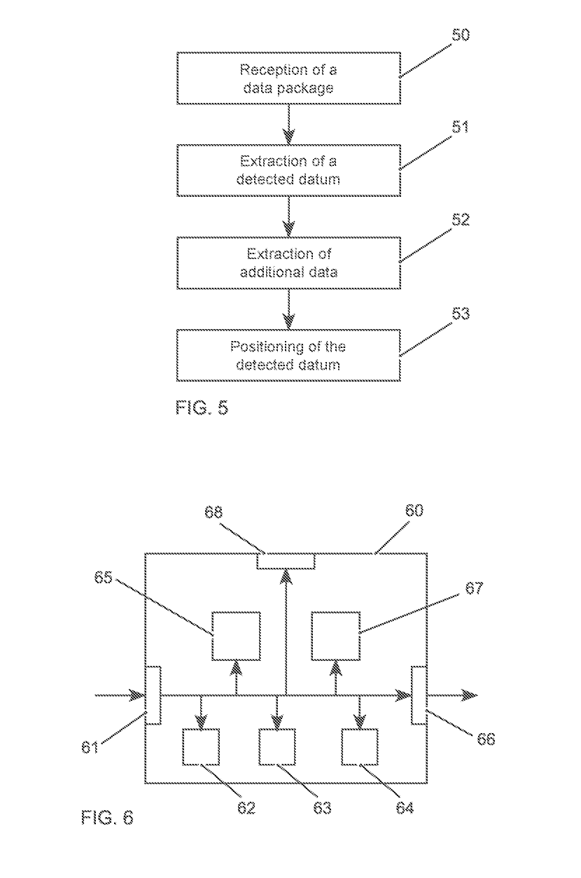

FIG. 5 schematically shows a method for locating a datum detected by a motor vehicle from the perspective of a back end. In a first step, a data package transmitted by a motor vehicle is received 50. Then at least one datum detected by a sensor system of the motor vehicle is extracted 51 from the received data package. Likewise, additional data are extracted 52 from the data package that make it possible to locate the at least one detected datum. For example, the detected local surroundings data can be information on visual landmarks. Finally, the at least one detected datum is positioned 53 based on the additional data. For positioning 53, local surroundings data detected by the sensor system of the motor vehicle and contained in the additional data are evaluated. To this end, the detected local surroundings data can be compared to a digital map.

FIG. 6 shows a simplified schematic representation of a first embodiment of a device 60 that can be installed in a back end for locating a datum detected by a motor vehicle. The device 60 has an input 61 to receive data that permit locating. A receiving unit 62 first receives a data package from a motor vehicle. In this context, the data package can be received by the motor vehicle directly after the transmission, or only subsequent to temporarily being saved by the receiving unit 62. A data processing unit 63 extracts from the data package at least one datum detected by a sensor system of the motor vehicle as well as additional data that make it possible to locate the at least one detected datum. The additional data comprise at least local surroundings data that were detected by the sensor system of the motor vehicle. A positioning unit 64 then positions the at least one detected data based on the additional data. To this end, the positioning unit 64 evaluates the local surroundings data detected by the sensor system of the motor vehicle. The data generated by the positioning unit are provided for further processing by an output 66 of the device 60, or are stored in a database 69. The database 69 can be part of the device 60. Alternatively, it can also be connected via the output 66 to the device 60. The receiving unit 62, the data processing unit 63 and the positioning unit 64 can be controlled by a control unit 65. If necessary, settings of the receiving unit 62, the data processing unit 63, the positioning unit 64 or the control unit 65 can be changed by means of a user interface 68. The data accumulating in the device 60 can be stored in a memory 67 of the device 60, for example for later evaluation or for use by the components of the device 60. The receiving unit 62, the data processing unit 63, the positioning unit 64 as well as the control unit 65 can be realized as dedicated hardware, such as integrated circuits. Of course, they can, however, also be partially or completely combined or implemented as software that runs on a suitable processor such as a GPU. The input 61 and the output 66 can be implemented as separate interfaces or as a combined bidirectional interface.

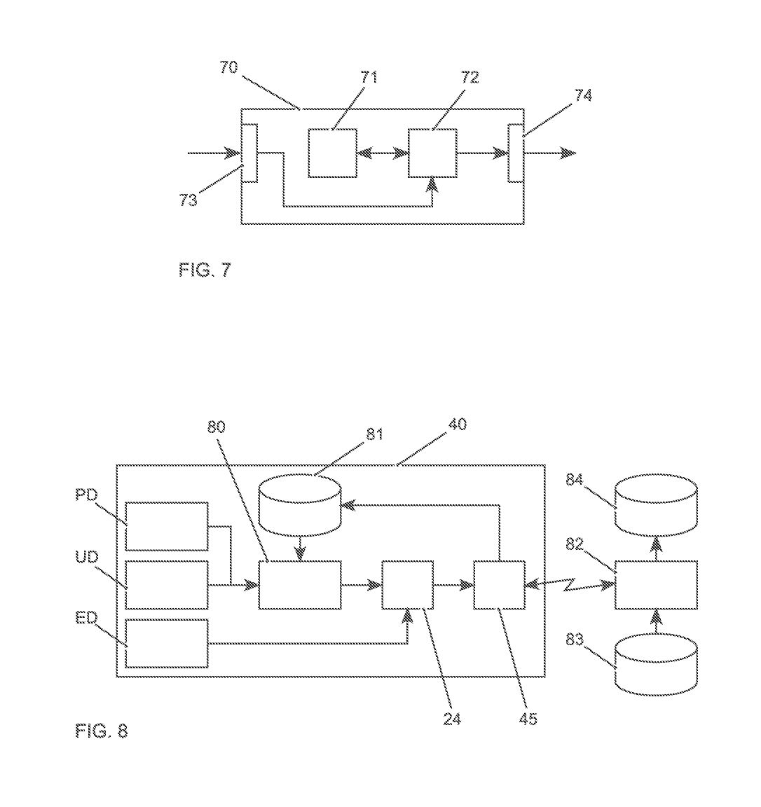

FIG. 7 shows a simplified schematic representation of a second embodiment of a device 70 that can be installed in a back end for locating a datum detected by a motor vehicle. The device 70 has a processor 72 and a memory 71. For example, the device 70 is a computer or a work station. Instructions are stored in the memory 71 that, when executed by the processor 72, cause the device 70 to execute the steps according to one of the described methods. The instructions stored in the memory 71 thus embody a program that can be executed by the processor 72 and realizes the method according to the discussion herein. The device has an input 73 for receiving information such as a data package that was transmitted by a motor vehicle. Data generated by the processor 72 are provided by an output 74. Moreover, they can be stored in the memory 71. The input 73 and the output 74 can be combined into a bidirectional interface.

The processor 72 can comprise one or more processor units such as microprocessors, digital signal processors, or combinations thereof.

The memories 67, 71 of the described embodiments can have volatile as well as non-volatile memory sections and can comprise a wide range of memory devices and media such as hard disks, optical storage media or semiconductor memories.

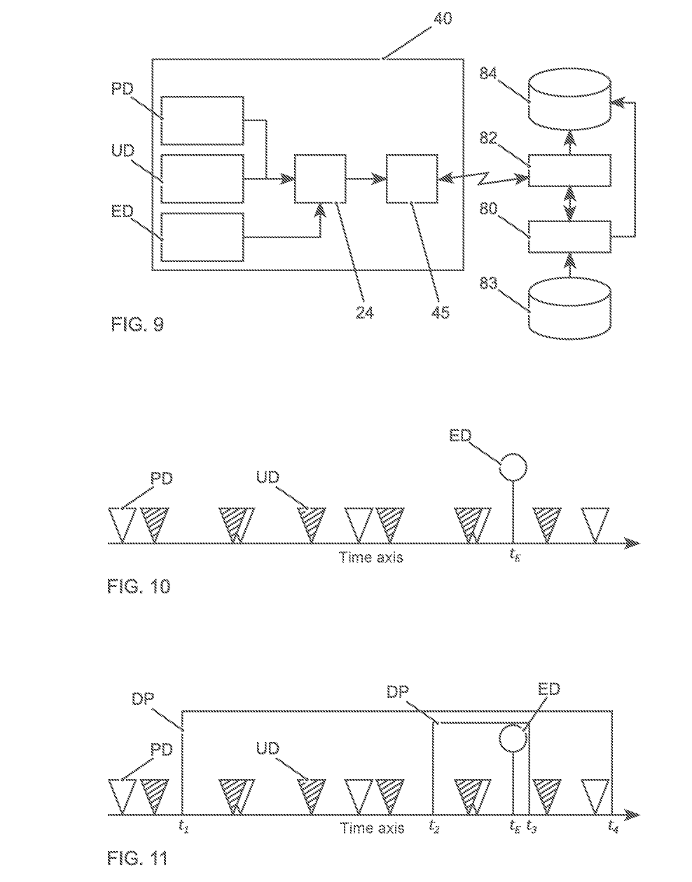

In the following, a further embodiment will be explained with reference to FIGS. 8 to 13.

FIG. 8 illustrates a known system for detecting and positioning data detected by a motor vehicle 40. Position data PD as well as surroundings data UD detected by a surround sensor system of the motor vehicle 40, such as lane markings, are provided to a positioning algorithm 80 of the motor vehicle 40. Based on these data, the positioning algorithm 80 determines a current position of the motor vehicle 40 with the assistance of a highly precise digital map 81. A datum ED also detected by the surround sensor system of the motor vehicle 40 is forwarded to a data processing unit 24 that generates a data package from the detected datum ED and the current position of the motor vehicle 40 determined by the positioning algorithm 80. This is transferred by a communication unit 45 to a back end 82. Based on the transmitted data package and an additional highly precise map 83, the back end determines the information that is entered into an event database 84.

FIG. 9 illustrates a system according to an embodiment of the invention for detecting and positioning data detected by a motor vehicle 40. According to the present embodiment, highly precise locating within the motor vehicle 40 is omitted. Instead, said locating is entirely performed in the back end 82. Position data PD, the surroundings data UD detected by a surround sensor system of the motor vehicle 40 as well as a datum ED detected by the surround sensor system of the motor vehicle 40 are forwarded to a data processing unit 24 which generates a data package from these data. This is transferred by a communication unit 45 to a back end 82. A positioning algorithm 80 in the back end now determines the information that is entered into an event database 84 based on the transmitted data package and a highly precise map 83.

On a time axis, FIG. 10 schematically illustrates the continuous detection and saving of data PD, UD for positioning as well as the detection and saving of data ED for a local event. During the continuous detection, the data are detected at discrete, regular, or also irregular intervals in time and are recorded time-stamped by the sensors in a database according to their own measuring frequency. In a specific example, position data PD at a first measuring frequency and surroundings data UD at a second measuring frequency are detected and saved. In the process, different measuring frequencies can be used for the different measurements. At time t_{E}, data ED for a local event are detected and saved.

FIG. 11 illustrates the generation of a data package as a reaction to a detected event. To send the data, they are taken from the database according to the localization requirements, linked to a data package DP and sent. The localization requirements depend on the type of event. A locally recognized pothole, for example, has a high localization requirement so that the generated data package DP comprises a relatively large amount of data. In FIG. 11, these are the position data PD and surroundings data UD detected between times t₁ and t₄. For large-area events such as black ice, only a slight amount of data must be sent. In FIG. 11, these are the position data PD and surroundings data UD detected between times t₂ and t₃. The required data transfer can thereby be minimized.

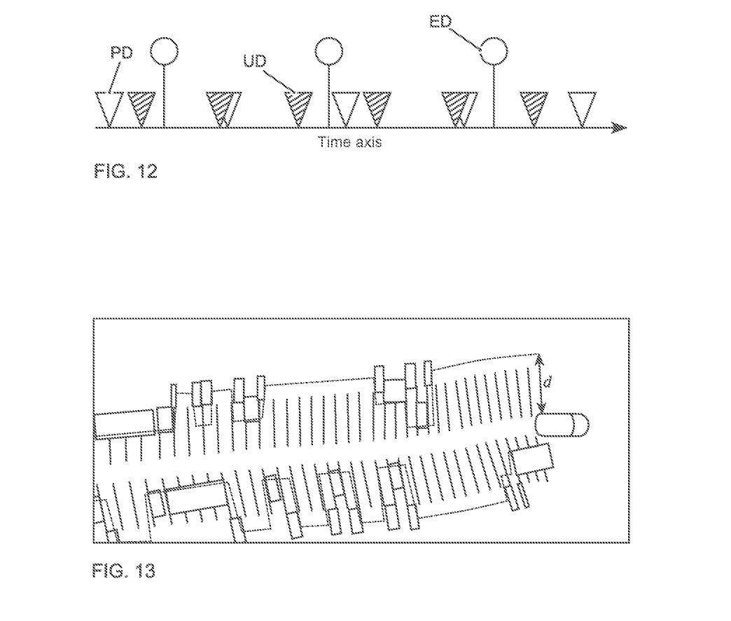

FIG. 12 shows the continuous detection and saving of local data ED and data PD, UD for positioning. Independent of a special event, local data ED are continuously detected, such as climate data or data from the ultrasonic sensors of a park assist. As addressed above, continuous detection involves discrete measurements at regular or also irregular intervals in time. The detected local data ED are continuously archived with the data PD, UD needed for positioning. The size of the data packages generated from this data can depend on the localization requirements as above.

According to the above-described structures, a continuous stream of data from the vehicle to the back end is unnecessary. The data are only transmitted when there are recognized local data in the vehicle that are relevant in this regard, for example because a relevant event was identified, or a specific request for data exists. This ensures that transfer costs are only generated when there is a corresponding benefit in the data.

FIG. 13 illustrates the use of continuous detection and saving of local data and data for positioning with the example of parking space data. In this example, consistent distances d are detected (dashed line) and compiled into a data set per second. The distances can for example be detected by ultrasonic sensors of the motor vehicle 40. The data which are generated thereby can be integrated in a particularly advantageous manner into the structure described in FIG. 12 and can be enriched with position data as needed. In this context, it is possible to enrich not only areas around the parking data with data for position determining, but also to generally adapt the measuring frequency of the data for determining the position corresponding to the position determining method in the backed.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit may fulfil the functions of several items recited in the claims.

The mere fact that certain measures are recited in mutually different dependent claims or embodiments does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

### REFERENCE NUMBER LIST

10 Detection of a datum
11 Determination of additional data
12 Filing of the data in the memory
13 Generation of a data package
14 Transmission of the data package
20 Device
21 Input
22 Data detection unit
23 Additional data determining unit
24 Data processing unit
25 Control unit
26 Output
27 Memory
28 User interface
30 Device
31 Memory
32 Processor
33 Input
34 Output
40 Motor vehicle
41 Navigation system
42 Surround sensor system
43 Network
44 Memory
45 Communication unit
50 Reception of a data package
51 Extraction of a detected datum
52 Extraction of additional data
53 Positioning of the detected datum
60 Device
61 Input
62 Reception unit
63 Data processing unit
64 Positioning unit
65 Control unit
66 Output
67 Memory
68 User interface
69 Database
70 Device
71 Memory
72 Processor
73 Input
74 Output
80 Positioning algorithm
81 Map
82 Back end
83 Map
84 Event database
PD Position data
UD Surroundings data
ED Detected datum
DP Data package

What is claimed is:

1. A method for locating a datum detected by a motor vehicle comprising the steps:
detecting at least one datum by means of a sensor system of the motor vehicle;
determining additional data that enable a locating of the at least one detected datum; and
generating a data package by linking the additional data to the at least one detected datum;
wherein the additional data comprise at least local surroundings data detected by the sensor system of the motor vehicle.

2. The method according to claim 1, wherein the at least one detected datum and the additional data are stored in a memory of the motor vehicle.

3. The method according to claim 1, wherein the data package is transmitted to a back end independently or as a reaction to a request.

4. The method according to claim 1, wherein data continuously detected by the sensor system of the motor vehicle and additional data are linked into data packages, or a data package is generated as a reaction to the at least one detected datum.

5. The method according to claim 1, wherein a scope of the additional data in a data package depends on the type of the at least one detected datum.

6. A method for locating a datum detected by a motor vehicle comprising the steps:
receiving a data package from a motor vehicle;
extracting from the data package at least one datum detected by a sensor system of the motor vehicle;
extracting from the data package additional data that allows to locate the at least one detected datum; and
positioning the at least one detected datum based on the additional data;
wherein local surroundings data detected by the sensor system of the motor vehicle and contained in the additional data are evaluated for positioning.

7. The method according to claim 6, wherein the positioning of the at least one detected datum comprises a comparison of the detected local surroundings data to a digital map.

8. The method according to claim 6, wherein the local surroundings data detected by the sensor system of the motor vehicle comprise information on visual landmarks.

9. The method according to claim 8, wherein the visual landmarks comprise one or more of the following elements: Lane markings, lane boundaries, road markings, traffic signs, guideposts, guard rails, traffic lights and construction objects.

10. The method according to claim 9, wherein the information on lane markings comprises one or more of the following elements: Information on the distance from a lane marking, information on the existence of a lane marking, information on the color of a lane marking, information on the type of lane marking, information on the curvature of a lane marking, and information on a yaw angle of the motor vehicle.

11. A computer-readable storage medium with instructions that, when executed by a computer, cause the computer to execute the steps of a method according to claim 1 for locating a datum detected by a motor vehicle.

12. A device for locating a datum detected by a motor vehicle having:
a data detection unit for detecting at least one datum by means of a sensor system of the motor vehicle;
an additional data determining unit for determining additional data that enable a locating of the at least one detected datum; and
a data processing unit for generating a data package by linking the additional data to the at least one detected datum;
wherein the additional data comprise at least local surroundings data detected by the sensor system of the motor vehicle.

13. A device for locating a datum detected by a motor vehicle having:
a receiving unit for receiving a data package from a motor vehicle;
a data processing unit for extracting from the data package at least one datum detected by a sensor system of the motor vehicle, and for extracting from the data package additional data that make it possible to locate the at least one detected datum; and
a positioning unit for positioning the at least one detected datum based on the additional data;
wherein the positioning unit is configured to evaluate local surroundings data detected by the sensor system of the motor vehicle and contained in the additional data for positioning.

14. A motor vehicle having a device according to claim 12.

15. A motor vehicle configured to execute a method according to claim 1 for locating a detected datum.
